(19) United States
(12) Patent Application Publication
(10) Pub. No.: US 2022/0312688 A1
(43) Pub. Date: Oct. 6, 2022

(54) PLANT SUPPORT CAGE ASSEMBLY FOR USE WITH TROLLEY CONVEYOR

(71) Applicant: KOREA WHEEL CORPORATION, Boryeong-si (KR)

(72) Inventor: Hun CHOE, Boryeong-si (KR)

(73) Assignee: KOREA WHEEL CORPORATION, Boryeong-si (KR)

(21) Appl. No.: 17/219,865

(22) Filed: Mar. 31, 2021

(51) Int. Cl. A01G 9/12; B65G 17/38

(52) U.S. Cl. CPC A01G 9/12; B65G 17/38

(57) ABSTRACT

A plant support cage assembly useful for growing plants in an upright configuration is provided for use with a trolley conveyor. A plurality of vertical support elements of selected length are provided spaced apart circumferentially about a vertical axis. Vertical support elements have an upper end and a lower end. At least some vertical support elements include an inwardly sloping lower portion. A plant container receiving portion is formed in part by the inwardly sloping lower portions vertical support elements, and by one or more plant container retaining hoops which are sized and shaped for receiving and containing therein a plant container of complementary size and shape. Coupling bars are provided affixed to and crossing under the plant container receiving portion, and extending outward therefrom for use in containment of plant stems. A plurality of hoop elements are provided, horizontally oriented and spaced apart vertically, and each affixed to at least some of the vertical support elements. One or more connector portions are provided above and affixed to the upper end of the vertical support elements. The connector portions are adapted for attachment of the plant support cage assembly to a trolley conveyor in a plant factory.

### STATEMENT OF GOVERNMENT INTEREST

Not Applicable.

### COPYRIGHT RIGHTS IN THE DRAWING

A portion of the disclosure of this patent document contains material that is subject to copyright protection. The patent owner has no objection to the facsimile reproduction by anyone of the patent document or the patent disclosure, as it appears in the Patent and Trademark Office patent file or records, but otherwise reserves all copyright rights whatsoever

### RELATED PATENT APPLICATIONS

None

### TECHNICAL FIELD

This disclosure relates generally to the field of horticulture, and more particularly, to indoor horticulture, and more specifically, to apparatus and devices for support of plants while suspended from an endless track trolley conveyor system.

### BACKGROUND

Plant factories that grow plants in large quantities for sale are increasingly common. However, when cultivating plants in a plant factory, there is limited space available in which to grow plants, especially vine plants which, as they grow, become attached to or wrapped around support objects. When grown outdoors, such vine plants might become attached to stakes or wire, or become wrapped around trees or fences or the like. Also, in the case of fruit plants such as peppers, eggplants, and cucumbers, the weight of the fruit is heavy, and as a result, the growing stem of a plant does not grow straight, but grows inclined to the side. Thus, there is a need to address plant support issues when growing plants in a plant factory.

### SOME OBJECTS, ADVANTAGES, AND NOVEL FEATURES

An object of the invention(s) disclosed herein is to solve the above-described problem, by providing a plant support cage assembly capable of supporting a plant in a configuration wherein fruit plants and vine plants can grow in a substantially upright manner.

Another object of the invention(s) disclosed herein is to provide a plant support cage assembly that can be detachably coupled to a trolley conveyor provided on the ceiling of a plant factory, so that the plant can be moved to a desired working location, or storage or growing location, or may be detached from the trolley conveyor.

Yet another object of the present invention is to provide a plant support cage assembly which may be used to neatly arrange branches that grow out of the lower part of the plant, so that the growing branches of a plant are neatly and aesthetically arranged.

It is an advantage that plants grown in the plant support cage assembly disclosed herein reduce labor for handling plants and picking fruit and vegetables grown therein or thereon, as the fruit or vegetables are easily accessed at a workstation when using a trolley conveyor for transport of such plant support cage assemblies.

It is an advantage of the plant support cage assembly disclosed herein are easily transportable on a trolley conveyor, for ease of movement in a plant factory.

The above objects and various advantages of the invention(s) as disclosed herein will become more apparent from the description provided and details of various embodiments, as will be understood by those skilled in the art.

### SUMMARY

A novel plant support cage assembly design has been developed and is described herein. The plant support cage assembly includes a planter receiving portion in which a plant container is placed, and in which plants to be grown are planted.

In an embodiment, the plant stem support cage may be provided using a plurality of vertically extending support elements which have affixed thereto a plurality of substantially horizontally oriented rings or hoops arranged at spaced apart height intervals. In an embodiment, the substantially oriented rings or hoops may be provided with a uniform diameter. In an embodiment, the vertically extending support elements may include, at the lower portions thereof, an inwardly turned lower portion, which is shaped and sized to provide a support portion for securely supporting a plant container in which plants may be grown. One or more planter support rings may be affixed to the inwardly turned lower portion of the vertically extending support elements. The planter support rings may be of smaller diameter than the diameter of the preferably substantially horizontally oriented rings or hoops. The lower ends of the vertically extending support elements may be affixed to a lowermost horizontal planter support ring.

Below the lowermost horizontal planter support ring, at least one coupling bar, with upturned end, may be provided. The at least one coupling bar(s) may be used for receiving stems of plants that are growing from the planter. In an embodiment, the at least one coupling bar extends outward in a horizontal direction. In an embodiment, the at least one coupling bar may be provided as a pair of coupling rods formed to cross each other in a “+” shape, and formed with an upturned portion at the ends, with the upturned portions extending upward in a vertical direction at both ends for a predetermined height. The upturned portions may be used to prevent the plant stems extending outward from extending substantially beyond the upturned portions.

At the top of the plant support cage assembly, a connector portion extends upward from and is connected to the vertically extending support elements. The connector portion may be provided in the form of one or more upwardly pointed V-shaped elements, where the lower ends of the V-shaped elements are connected to one of the vertically extending support elements. The connector portion is coupled by suitable device such as a hook to a trolley conveyor. The hook may be a component of a support coupling assembly which is used to attach a plant support cage assembly to a specific location along the length of a trolley conveyor. In an embodiment, the plant support cage assembly may be detachably coupled to the support coupling assembly.

In an embodiment, the plant support cage assembly may be detachably coupled to a trolley conveyor that is provided with a track along a defined path and supported from an overhead or ceiling support in a plant factory. A moveable endless chain unit is provided inside the track. With the trolley conveyor, a plant support cage assembly can be moved within a plant factory as necessary for planting, maintenance, growth, and harvest. The plant support cage assembly as described therein may be used to support various types of plants, including large plants with sizeable fruits and vegetable products, including peppers, eggplants, and cucumbers, which can be grown in an upward configuration, rather than in a sideways configuration, using the plant support cage assembly described herein.

### BRIEF DESCRIPTION OF THE DRAWING

The present invention(s) are described herein by way of exemplary embodiments, using for illustration the accompanying drawing in which like reference numerals denote like elements in the various figures of the drawing, and in which:

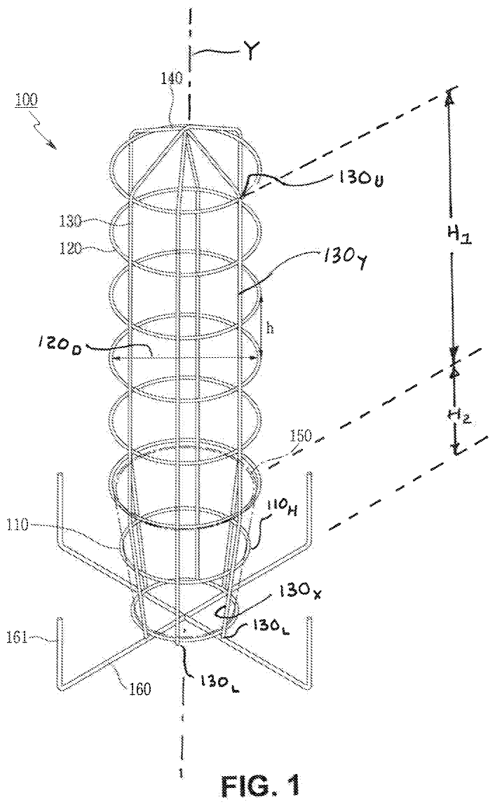

FIG. 1 is an exemplary perspective view of a plant support cage assembly as described herein, showing the use of vertical support elements, a plurality ring or hoop elements which are spaced apart vertically and affixed to the vertical support elements, and connector portions located above and connected to the top end of the vertical support elements, as well as inwardly sloping lower portions of the vertical support elements that form a planter support portion having one or more planter support rings that may be affixed to the inwardly turned lower portion of the vertically extending support elements, and the use of a pair of coupling bars located below the planter support portion, the coupling bars having upwardly turned ends for use in containing outwardly growing stem portions of plants being grown in the planter.

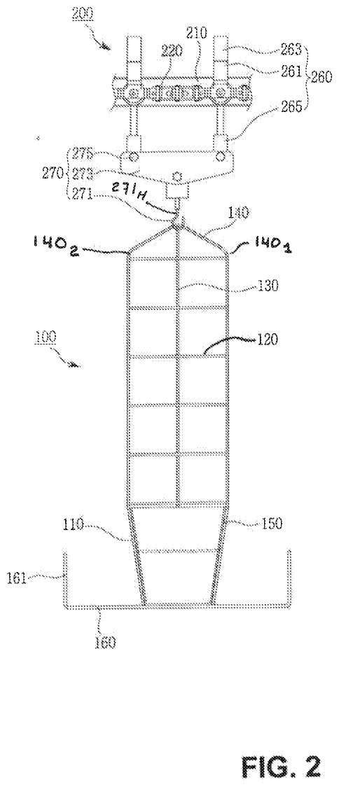

FIG. 2 is a side elevation view, illustrating a plant support cage assembly in use, and providing a partially cut away view of the trolley conveyor track at the top, and of the planter support portion at the bottom, showing how the plant support cage assembly is detachably affixed to the trolley conveyor.

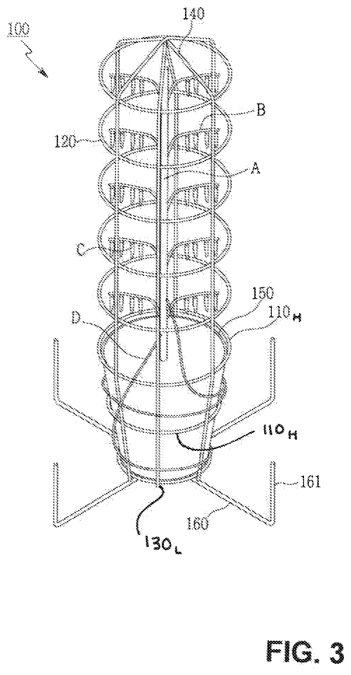

FIG. 3 is a perspective view of a plant support cage assembly in use, but detached from the trolley conveyor, showing the plant support cage assembly supporting the growth of pepper plants.

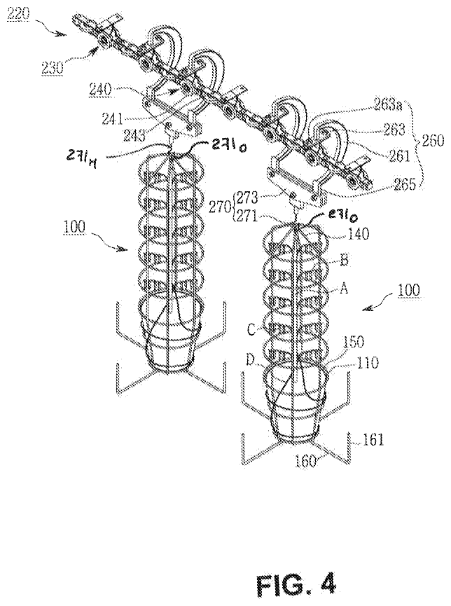

FIG. 4 is a perspective view of a pair of plant support cage assemblies in use, attached to a trolley conveyor, showing the plant support cage assemblies each supporting the growth of pepper plants.

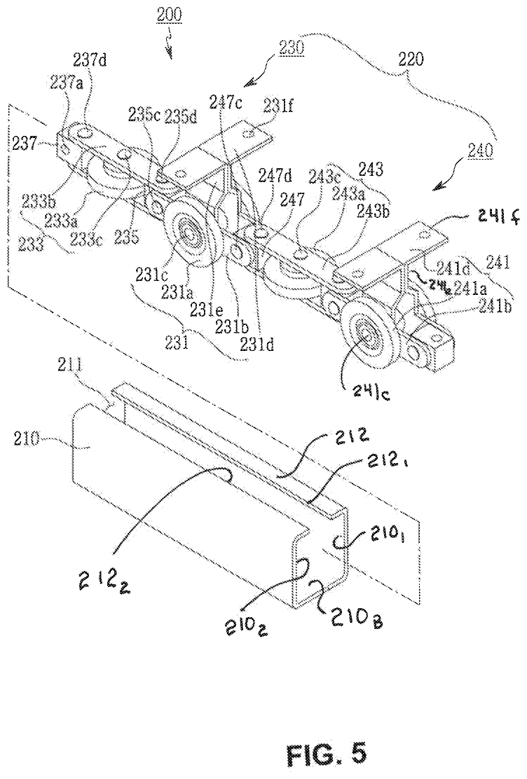

FIG. 5 is an exploded perspective view showing an embodiment for components of a track and a portion of an endless chain for a trolley conveyor.

The foregoing figures, being merely exemplary, contain various elements that may be present or omitted from a particular final configuration for an embodiment of a plant support cage assembly for use with a trolley conveyor system. However, there is no intention to limit the claimed invention to dimensional data, and any suggestion provided by any of the drawing figures of this specification are exemplary rather than mandatory. Thus, the materials of construction, and the techniques and materials used for joining various components may be provided sized up or down from any dimensions depicted, without affecting the scope of the appended claims. An attempt has been made to draw the figures in a way that illustrates at least those elements that are significant for an understanding of exemplary plant support cage assembly for use with a trolley conveyor system, and particulars may be varied for specific situations.

It should be understood that various features may be utilized in accord with the teachings hereof, as may be useful in different embodiments, depending upon the specific requirements such as spacing between horizontal elements, or vertical space available between the trolley conveyor system and the floor below, all within the scope and coverage of the teachings herein as defined by the claims. Further, like features in various embodiments may be described using like reference numerals, or other like references, without further mention thereof.

### DETAILED DESCRIPTION

Attention is directed to FIG. 1, where an exemplary design for a plant support cage assembly 100 is provided. The plant support cage assembly 100 includes a plurality of vertical support elements 130, which are spaced apart circumferentially about a vertical axis Y. Each of the vertical support elements 130 has an upper end 130_{U} and a lower end 130_{L}. At least some of the vertical support elements 130 further include an inwardly sloping lower portion 130_{X}. In an embodiment, a plant support cage assembly 100 may be provide where the plurality of vertical support elements 130 is made up of six vertical support elements 130. An upper straight portion 130_{Y} of the vertical support elements 130 may extend upward for a distance of H₁.

A plant container receiving portion 110 is provided. The plant container receiving portion 110 may be formed by the inwardly sloping lower portion 130_{X} of at least some of the vertical support elements 130, in combination with one or more plant container retaining hoops 110_{H}. The plant container receiving portion 110 is sized and shaped for receiving therein a plant container 150 of complementary size and shape. The plant container receiving portion 110, which includes the inwardly sloping lower portion 130x of vertically support elements 130, may extend upward for a distance of H₂. However, the design as described is only an example and the functional components may be provided in a variety of cage or mesh forms, whether of metal or other material capable of supporting the weight of the plant container 150. Thus, it should be understood that the plant container receiving portion 110 may be provided in various ways, and a final design may be selected according to the size of the plant container 150, or may be bent or narrowed according to the size of the plant container 150 to be used.

At least one coupling bar 160 is affixed to and crosses under the plant container receiving portion 110, and extends generally horizontally outward. In an embodiment, one or more of the at least one coupling bars 160 further includes at least one upturned end portion 161. In an embodiment, each of the at least one coupling bars 160 includes an upturned end portion 161. In various embodiments, the at least one upturned end portion 161 extends vertically.

The plant support cage assembly 100 further includes a plurality of hoop elements 120. In an embodiment, the hoop elements may be oriented in substantially a horizontal configuration. In various embodiments, any two of the plurality of hoop elements 120 may be spaced apart vertically by a distance h, as noted in FIG. 1 when oriented horizontally. Each one of the plurality of substantially horizontal hoop elements 120 are affixed to at least some of the vertical support elements 130. The hoop elements 120 may also be integrally formed with, or configured for integrally fixed interlocking attachment, such as by interfitting concave surfaces which may be provided on the vertically extending support elements 130 or in the horizontal loop elements 120, or both. In various embodiments, the hoop elements 120 may be provided in a selected metal composition. In an embodiment, a plant support cage assembly 100 may be provided wherein one or more of the plurality of hoop elements is circular, and has a diameter 120_{D}. The diameter 120_{D} may be varied as appropriate for plants being grown. In an embodiment, the plant support cage assembly 100 may be provided with one or more plant container retaining hoops 110_{H} each having a diameter 110_{D}, and wherein the diameter 110_{D} is less than the diameter 120_{D}.

In various embodiments, a plant support cage assembly 100 may further include one or more connector portions located above and affixed to the upper end of the vertical support elements 130. In an embodiment, each of the one or more the connector portions 140 are provided in an inverted V-shape with first 140₁ and second 140₂ ends, and wherein the first 140₁ and second 140₂ ends are each affixed to one of the vertical support elements at the upper end 130_{U} thereof. As seen in FIG. 1, in an embodiment, a plant support cage assembly 100 may be provided with three connector portions 140. The connector portions 140 are configured and juxtaposed as appropriate in a particular design and provided with the size and mechanical strength, given materials of construction, and which are sufficient within customary design requirements for similar structures to support the plant support cage assembly 100 when fully loaded and in use having a workpiece plant container 150 therein, and with a growing plant situated therein, recognizing weight may increase over time with watering, fertilization, and growth of fruit or vegetables in a plant factory. Note, however, while an exemplary connector portion 140 design has been provided, a connector portion may be provided in various forms. It would be especially advantageous if the connector portion 140 enables the plant support cage assembly 100 to be detachably coupled to the trolley conveyor 200. Thus, the connector portion 140 may be transformed into a ring shape or a hook shape as may be useful in specific circumstances. For example, as seen in FIG. 4, the plant support parts 270 may include a pair of hanger coupling brackets 273 coupled with the bracket so coupling plate 265 of the hangers 260, and coupler between the endless chain 220 and the pant support cage assembly 100 includes a ring 271_{O} as well as a hook 271_{H}.

In an embodiment, the plant support cage assembly 100 may be advantageously utilized with a trolley conveyor 200. In an embodiment, a trolley conveyor 200 may be provided having a stationary tubular rail track 210. The stationary tubular rail track 210 has a bottom wall 210_{B}, inner sidewalls 210₁ and 210₂, and a slotted upper wall 212 defining an open slot 211 between upper end walls 212₁ and 212₂.

A trolley conveyor 200 is provided. A trolley chain with repeating units 220 is installed inside the stationary tubular rail track 210 for longitudinal movement with respect to the stationary tubular rail track 210. A trolley chain is made up of endlessly joined chain portions 220, with each chain portion 220 having a first chain unit 230 and a second chain unit 240. The first chain unit 230 further includes a first chain link 231 with body 231b portions and which has a pair of vertical rollers 231a rotatably affixed thereto for rotation on the bottom wall 210_{B} of the stationary tubular rail track 210. The vertical rollers 231a and 241a are sized and shaped for ease of rolling action within the stationary tubular rail track 210, and more specifically, to ride along on the bottom wall 210_{B} of the stationary tubular rail track 210. A bearing (not shown) may be provided between the vertical roller 231a and shaft 231c, and between the vertical roller 241a and the shaft 241c. The first chain unit 230 also so includes a second chain link 233 with body 233b portions and which includes one or more horizontal rollers 233a for rotation against at least one of the inner sidewalls 210₁ and 210₂ of the stationary tubular rail track 210. The horizontal rollers 233a and 243a are sized and shaped for ease of rolling action within the stationary tubular rail track 210. A bearing (not shown) may be provided between the horizontal roller 233a and shaft 233c, and between the horizontal roller 243a and the shaft 243c. The first chain link 231 and the second chain link 233 of the first chain unit 230 are pivotally attached each to the other at an intermediate pivot block 235, having horizontal pivot pin 235c and vertical pivot pin 235d there through, disposed for pivoting motion.

Similarly, the second chain unit 240 further includes a third chain link 241 with body 241b portions and which has a pair of vertical rollers 241a rotatably affixed thereto for rotation on the bottom wall 201_{B} of the stationary tubular rail track 210. The second chain unit 240 also includes a fourth chain link 243 with body 243b portions and which includes one or more horizontal rollers 243a for rotation against at least one of the inner sidewalls 210₁ and 210₂ of the stationary tubular rail track 210. The third chain link 241 and the fourth chain link 243 of the second chain unit 240 are pivotally attached each to the other at an intermediate pivot functionally similar or identical to previously described pivot block 235 and has a having horizontal pivot pin and vertical pivot pin there through (omitted for drawing clarity), disposed for pivoting motion, as earlier described. Similarly, the first chain unit 230 and the second chain unit 240 are pivotally attached each to the other at an intermediate pivot 247 functionally similar or identical to the previously described pivot block 235 and has a having horizontal pivot pin 247c and vertical pivot pin 247d there through, disposed for pivoting motion, as earlier described. Likewise, sequential chain portions 220 are pivotally attached each to the other with end pivot blocks 237, utilizing horizontal pivot pins 237a and vertical pivot pins 237d.

Necks 231e and 241e extend upward from adjacent the trolley chain units 230 and 240, and extend upward between, with clearance from, and then upward beyond the slot 211 defined by upper end walls 212₁ and 212₂ in the slotted upper wall 212 of the stationary tubular rail track 210. The necks 231e and 241e then support one or more laterally extending attachment flanges 231d and 241d.

A plurality of hangers 260 are provided. Each one of the plurality of hangers 260 has an upper end 263. The upper end 263 includes downwardly extending connectors configured for attachment of the hangers to the one or more attachment flanges 231d or 241d. The hangers 260 have a lower end 265 configured to attach plant support parts 270 therefrom. A hanger body 261 extends between the upper end 263a and the lower end 265.

Plant support parts 270 provide apparatus for connection of the plant support cage assembly 100 to the hangers 260. The plant support parts 270 include body 273, which may be secured to hanger 260 by fasteners 275, and a coupler 271. The coupler 271 is detachably affixed to the connector portions 140 of the plant support cage assembly 100, so that the plant support cage assembly 100 is vertically suspended from the coupler 271 for transport via the trolley conveyor 200. In an embodiment, the coupler 271 may be provided in the form of a hook. In an embodiment, the plant support parts 270 may include a pair of bracket coupling plates 273, wherein the bracket coupling plates 273 connected to two adjacent hangers 260.

A first hanger coupling flange 231d is formed to extend a predetermined area horizontally from the upper portion of the first neck 231e and is coupled to the flange coupling plate 263 of the hanger 260. First fastening holes 231f are formed on both sides of the first hanger coupling flange 231d, and are coupled to the hanger 260 by the flange coupling plate 263 and the first fastening member 263a. Similarly, a second hanger coupling flange 241d is formed to extend a predetermined area horizontally from the upper portion of the first neck 231e and is coupled to the flange coupling plate 263 of another hanger 260. Second fastening holes 241f are formed on both sides of the second hanger coupling flange 241d, and are coupled to a second hanger 260 by a flange coupling plate 263 and another fastening member 263a.

As shown and described, the hanger body 261 of hangers 260 is arranged eccentrically on one side of the stationary tubular rail track 210 in a “C” shape. Thus, the load of the plant support cage assembly 100 is provided under the hangers 260, and may become eccentric, i.e. tends to load off to the side. Consequently, if the hanger body 261 is eccentric in this way, it was found that the chain 220 might be inclined toward one side of the stationary tubular rail track 210, and thus not move smoothly. In order to solve this problem, the chain 220 of the present invention provides a continuous chain in which the vertical rollers and the horizontal rollers are alternately arranged.

The substantially horizontal hoop elements 120 are provided to enable a grower to use the hoop elements 120 to reinforce a plant stem in the plant being grown, as seen in FIGS. 3 and 4. Advantageously, the substantially horizontal hoop elements may be provided at selected heights above the plant container 150, to support various kinds of plants and their stems, as they grow upward from plant container 150. Importantly, the substantially horizontal hoop elements 120 are advantageous since they can support the weight of various fruits or vegetables growing on a plant, and in particular, may provide support so that the plant does not bend sideways to one side or the other. Importantly, the height h between hoop elements 120 (when in a substantially horizontal configuration) may be varied, depending on the type of plant to be grown in the plant support cage assembly 100. Such selection may be guided by the type of plant and the size, shape, and weight of the fruit or vegetable being produced in a plant factory. Additionally, the diameter 120_{D} of the hoop elements 120 may be varied, according to the type of plant to be grown in a plant support cage assembly 100.

In various embodiments, a plant container is accommodated in the plant container receiving portion 110 of the plant support cage assembly 100. In use, plants are planted in the plant container 150. The plant container 150 provides a structure in which water can be drained downward and out of the plant container 150. Soil is accommodated in the plant container 150, and plants are planted in the soil. In an embodiment, a plant container may preferably be provided in a material having as light weight as possible, since reduced weight will result in reduced power requirements for movement of the plant support cage assemblies 100 via the trolley conveyor 200. As plants grow, stems D (see FIG. 4) may grow outward from the plant container 150. The extending stem coupling bar 160 may be used to organize extending stems of plants planted in the plant container 150. In an embodiment, a pair of extending stem coupling bars 160 may be provided, formed by an intersecting pair of metal rods in a “+” shape. Such as design is only a suggested embodiment, as the extending stem coupling bar(s) 160 may also be formed by arranging a plurality of metal rods radially. At the end of each extending stem coupling bar 160, a vertical support bar 161 may be provided to enable the grower to prevent the extending stem of a plant from extended too far laterally from the plant container 150. When a large number of extending stems are wound between the coupling bar(s) 160 and the plant container receiving portion, the extending stems may be properly separated by use of the extending stem coupling bars 160.

Attention is directed to FIG. 3, where an exemplary view shows a case where peppers are planted in the plant support cage assembly 100. As shown, the central stem (A) of the pepper grows toward the top, and a plurality of side branches (B) grow irregularly toward the side in the height direction from the central stem (A). A red pepper fruit (C) is found located on the side branches (B). At the same time, since an irregular number of pepper fruit (C) are opened in an irregular direction, the center of gravity is offset, so the central stem (A) may be bent. Thus, using the plant support case assembly 100 as described herein, the side branches (B) are mounted on the plant stem support provided by hoops 120, to distribute and support the weight of the pepper fruit (C). This technique allows the central stem (A) to grow straight up in the vertical direction. In addition, as time passes, the extending stems (D), which grow outward from the lower part of the central stem (A), are wound around the plant container receiving portion 110, and may be arranged by the grower.

That is, the extending stems (D) may be wound and arranged in the space between the plant container support portion 110 and the plurality of vertical support bars 161. Accordingly, when the plant support cage assembly 100 is moved along the trolley conveyor 200, as shown in FIG. 4, the extending branches of plants therein are arranged in the plant support cage assembly 100 in a manner that prevents interference with each other. Thus, plants in a plant support cage assembly 100 may be neatly arranged.

Also, plants having large fruits such as eggplants and cucumbers can be cultivated using the plant support cage assembly 100, in the same manner as just described above. Also, various types of vine plants can also be cultivated using the plant support cage assembly 100 described herein. In the case of planting vine plants, the spacing between the plant stem support hoops 120 may be narrower, that is, they may be closely spaced a distance and thus be more dense, so that the vine can be stably supported.

More generally, the plant support cage assembly 100 allows a grower to grow plants while they are suspended from a trolley conveyor 200 in a plant factory, and allows plants to be moved around via the trolley conveyor 200. Importantly, the plants located in the plant containers 150 are not located on the ground, and thus the plants are allowed to grow while they are suspended in the air, and are from time to time transported via the trolley conveyor 200.

The trolley conveyor 200 is moved along, when desired, under the control of a control unit (not shown) of a plant factory to enable the grower to control the positions of a plurality of plant support cage assemblies 100, and thus control the planting, growing, and harvesting locations and conditions in a plant factory. As an example, the amount of sunlight (or artificial light) received by plants in the plant container in each of the plant support cage assemblies 100 may be equally adjusted, or varied as appropriate. Likewise, the plurality of plant support cage assemblies 100 may be periodically moved to a water supply area, where the plants may be watered as appropriate.

By use of the above described apparatus and methods, bulky fruits such as cucumbers, with otherwise unwieldy branches and stems, may be planted in plant containers on a plant support cage assembly, and coupled to the trolley conveyor 200, so that they can be grown under uniform growing conditions. This method, and use of the apparatus described herein, makes it possible to harvest fruits and vegetables of uniform quality.

In addition, when the growth is completed, and plants such as peppers, cucumbers, and eggplants need to be harvested, a worker may use the trolley conveyor 200 to move the plant support cage assemblies 100 to the place where a worker may pick and pack the ripened fruit or vegetables. This technique can greatly reduce the number of workers required, and thus reduce costs for the labor force required in a plant factory.

For further reference, FIG. 5 shows a perspective view of key portions of a trolley conveyor suitable for use with the plant support cage assembly 100 as described herein. As shown in FIGS. 4 and 5, the trolley conveyor 200 includes a stationary tubular rail track 210 formed in a predetermined path on the ceiling of a plant factory, an endless chain part 220 moving along the stationary tubular rail track 210. Many plant support cage assemblies 100 are suspended for transport by the trolley conveyor 200. However, since the key details have already been described hereinabove, they need not be repeated.

The endless chain unit 220 is driven by a chain driving unit (not shown). In an embodiment, a plurality of chain drive units (not shown) may be provided on the outer side of the stationary tubular rail track 210 at regular intervals so that the endless chain unit 220 is smoothly urged to move along in stationary tubular rail track 210. In an embodiment, such chain driving units may be provided using an electric motor to drive a geared mechanism to interface with the endless chain unit 220. A suitable control system may be utilized within the plant factory for control of the drive of the endless chain unit 220, as those of skill in the art will readily appreciate and be able to design and supply.

Although only a few exemplary embodiments have been described in detail, various details are sufficiently set forth in the drawings and in the specification provided herein to enable one of ordinary skill in the art to make and use the invention(s), which need not be further described by additional writing in this detailed description. It will be readily apparent to those skilled in the art that the details as described herein may be useful in supporting and moving plants, especially plants which grow with vines, for growth and movement in a plant factory, and as such may be modified from those embodiments provided herein, without materially departing from the novel teachings and advantages provided.

Thus, the aspects and embodiments described and claimed herein may be modified from those shown without materially departing from the novel teachings and advantages provided, and may be embodied in other specific forms without departing from the spirit or essential characteristics thereof. Therefore, the embodiments presented herein are to be considered in all respects as illustrative and not restrictive. As such, this disclosure is intended to cover the structures described herein and not only structural equivalents thereof, but also equivalent structures. Numerous modifications and variations are possible in light of the above teachings. It is therefore to be understood that within the scope of the appended claims, the invention(s) may be practiced otherwise than as specifically described herein. Thus, the scope of the invention(s), as set forth in the appended claims, and as indicated by the drawing and by the foregoing description, is intended to include variations from the embodiments provided which are nevertheless described by the broad interpretation, scope, and range properly afforded to the plain meaning of the claims set herein.

1. A plant support cage assembly, comprising:
a plurality of vertical support elements, the plurality of vertical support elements spaced apart circumferentially about a vertical axis, each of the vertical support elements having an upper end and a lower end, and at least some of the vertical support elements further including an inwardly sloping lower portion;
a plant container receiving portion, the plant container receiving portion formed by the inwardly sloping lower portion of at least some of the vertical support elements and one or more plant container retaining hoops, the plant container receiving portion sized and shaped for receiving therein a plant container of complementary size and shape;
at least one coupling bar, the at least one coupling bar affixed to and crossing under the plant container receiving portion, and extending outward therefrom;
a plurality of hoop elements, the plurality of hoop elements spaced apart vertically and affixed to at least some of the vertical support elements; and
one or more connector portions located above and affixed to the upper end of the vertical support elements.

2. A plant support cage assembly as set forth in claim 1, wherein each of the one or more the connector portions are provided in an inverted V-shape with first and second ends, and wherein the first and second ends are each affixed to one of the vertical support elements at the upper end thereof, and wherein the connector portions have the size and mechanical strength sufficient to support the plant support cage assembly, when in use having a workpiece plant container with a growing plant situated therein.

3. A plant support cage assembly as set forth in claim 1, wherein each of the at least one coupling bars further comprises at least one upturned end portion.

4. A plant support cage assembly as set forth in claim 3, wherein the at least one upturned end portion extends vertically.

5. A plant support cage assembly as set forth in claim 1, wherein the hoop elements are oriented substantially in a horizontal configuration, and where any two of the plurality of hoop elements are spaced apart vertically by a distance h.

6. A plant support cage assembly as set forth in claim 1, wherein any one of the plurality of hoop elements is circular, and has a diameter 1200.

7. A plant support cage assembly as set forth in claim 1, wherein the plurality of vertical support elements comprises six vertical support elements.

8. A plant support cage assembly as set forth in claim 1, wherein the one or more connector portions include three connector portions.

9. A plant support cage assembly as set forth in claim 6, wherein the one or more plant container retaining hoops each have a diameter 110_{D}, and wherein the diameter 110_{D} is less than the diameter 120_{D}.

10. A combination of a plant support cage assembly and a trolley conveyor, comprising:
(a) a plant support cage assembly, the plant support cage assembly including a plurality of vertical support elements, the plurality of vertical support elements spaced apart circumferentially about a vertical axis, each of the vertical support elements having an upper end and a lower end, and at least some of the vertical support elements further including an inwardly sloping lower portion;
a plant container receiving portion, the plant container receiving portion formed by the inwardly sloping lower portion of at least some of the vertical support elements and one or more plant container retaining hoops, the plant container receiving portion sized and shaped for receiving therein a plant container of complementary size and shape;
at least one coupling bar, the at least one coupling bar affixed to and crossing under the plant container receiving portion, and extending outward therefrom;
a plurality of hoop elements, the plurality of substantially horizontal hoop elements spaced apart vertically and affixed to at least some of the vertical support elements;
connector portions located above and affixed to the upper end of the vertical support elements; and
(b) a trolley conveyor, the trolley conveyor comprising a stationary tubular rail track, the stationary tubular rail track having a bottom wall, inner sidewalls, and a slotted upper wall defining an open slot between upper end walls;
a trolley chain, the trolley chain installed inside the stationary tubular rail track for movement with respect to the stationary tubular rail track, the trolley chain comprising endlessly joined chain portions, each chain portion comprising a first chain unit and a second chain unit,
the first chain unit further comprising first chain link and a second chain link, the first chain link comprising a pair of vertical rollers rotatably affixed to the first chain link for rotation on the bottom wall of the stationary tubular rail track, and the second chain unit comprising at least one horizontal roller rotatably affixed to the second chain link for rotation against at least one of the inner sidewalls of the stationary tubular rail track, wherein the first chain unit and the second chain unit are pivotally attached each to the other at an intermediate pivot block,
the second chain unit further comprising third chain link and a fourth chain link, the third chain link comprising a pair of vertical rollers rotatably affixed to the third chain link for rotation on the bottom wall of the stationary tubular rail track, and the fourth chain unit comprising at least one horizontal roller rotatably affixed to the fourth chain link for rotation against at least one of the inner sidewalls of the stationary tubular rail track, wherein the third chain link and the fourth chain link unit are pivotally attached each to the other at an intermediate pivot block,
wherein sequential chain portions are pivotally attached each to the other with end pivot blocks;
necks extending upward from adjacent chain portions of the trolley chain, the necks extending upward between and beyond the upper end walls in the slotted upper wall of the stationary tubular rail track;
outwardly oriented attachment flanges extending laterally from the necks;
a plurality of hangers, each of the plurality of hangers comprising (1) an upper end, the upper end having downwardly extending connectors configured for attaching the hangers to the one or more of the outwardly oriented attachment flanges, (2) a lower end configured to hang plant support parts therefrom, and (3) a hanger body extending between the upper end and the lower end; and
(c) plant support parts, the plant support parts connected to the hangers, the plant support parts including a body and a coupler, wherein the coupler is detachably affixed to the connector portions of the plant support cage assembly, so that the plant support cage assembly is vertically suspended from the coupler for transport via the trolley conveyor.

11. A combination as set forth in claim 10, wherein the coupler comprises a hook.

12. A combination as set forth in claim 10, wherein the plant support parts comprise a pair of bracket coupling plates, the bracket coupling plates connected to two adjacent hangers in the plurality of hangers.
